(19) United States
(12) Patent Application Publication
(10) Pub. No.: US 2009/0202714 A1
(43) Pub. Date: Aug. 13, 2009

(54) Methods of Making and using Metal Oxide Nanoparticles

(76) Inventors: Natalia S. Mandzy, Lexington, KY (US); Eric A. Grulke, Lexington, KY (US); Thad L. Druffle, Louisville, KY (US)

Correspondence Address: MEYERTONS, HOOD, KIVLIN, KOWERT & GOETZEL, P.C., P.O. BOX 398, AUSTIN, TX, 78767-0398, US

(21) Appl. No.: 12/083,986

(22) PCT Filed: Nov. 21, 2006
(86) PCT No.: PCT/US06/45320

§ 371 Date: Mar. 23, 2009

Related U.S. Application Data
(60) Provisional application No. 60/738,642, filed on Nov. 21, 2005.

(51) Int. Cl. B29D 11/00; B05D 5/06

(52) U.S. Cl. 427/164; 264/1.7

(57) ABSTRACT

Described herein are electrostatically stabilized nanoparticles. Methods of manufacturing non-agglomerated crystalline nanoparticles in water and polar solvents and encapsulation of nanoparticles to assemble room temperature curable transparent nanoparticles/polymer composites arc also described.

### BACKGROUND OF THE INVENTION

1. Field of the Invention

The present invention relates generally to metal oxide nanoparticles. More particularly, the invention relates to methods of preparing metal oxide nanoparticles and using metal oxide nanoparticles.

2. Description of the Relevant Art

Non-agglomerated metal oxide nanoparticles have been synthesized by several methods. Typical methods for the synthesis of metal oxide nanoparticles may require costly equipment (e.g., a nitrogen filled glovebox or rotary evaporator), may rely on the use of expensive precursors, and/or may include many processing steps. Additional equipment, expensive chemical reagents, and numerous processing steps tend to add to the price of the final product. It would be generally desirable to be able to produce non-agglomerated metal oxide nanoparticles at a low cost of production.

Due to its photocatalytic activity, high refractive index, and absorption of ultraviolet (“UV”) radiation, titanium dioxide is an appealing additive for many industries. For example, addition of titanium dioxide to a polymer allows engineering of composites with a range of refractive indexes. Incorporation of titanium dioxide into a clear coating layer may reduce UV penetration into an underlying substrate and fading of the underlying surface if painted. Additionally, a film of titanium dioxide may be used to provide surfaces with self-cleaning and antimicrobial properties.

In the manufacturing of transparent films and composites, the size of the particles and/or agglomerates used to manufacturer such films and composites typically does not exceed 20 nm. To inhibit agglomeration of the particles during fabrication and processing, stabilizing agents may be added to the particles. These stabilizing agents typically reduce the refractive index of the resulting products formed from the stabilized agglomeration. These stabilizing agents are believed to act by attaching to the surface of the particles, thus preventing agglomeration by introducing steric barriers among the particles. These stabilizing agents tend to be large molecules that not only reduce the refractive index of the resulting products, but also often impede curing of the material. Electrostatic stabilization, on the other hand, may not require the presence of such stabilizing agents.

### SUMMARY

Nanoparticles may be made by a method that includes: forming a mixture of one or more solvents with one or more stabilizing agents; adding a metal alkoxide to the mixture; and heating the metal alkoxide mixture to form a suspension of nanoparticles in the one or more solvents. The resulting mixture comprises metal oxide particles having a diameter of less than about 50 nm. The metal oxide particles are substantially non-agglomerated. In some embodiments, the nanoparticles are crystalline.

A composition may be formed from the formed nanoparticles by adding the suspension of nanoparticles to an at least partially polymerized monomer. The resulting composition may be used to form a material having altered properties or forming a coating layer on a substrate. In some embodiments, the composition may also include a coupling agent having at least two functional groups.

In an embodiment, a lens may be formed by applying a coating composition to a casting face of a mold member, the coating composition comprising nanomaterials, one or more initiators, and one or more monomers, wherein the nanomaterials are made by the method comprising: forming a mixture of one or more solvents with one or more stabilizing agents; adding a metal alkoxide to the mixture; and heating the metal alkoxide mixture to form a suspension of nanoparticles in the one or more solvents. The coated mold member may be assembled into a mold assembly, the mold assembly including the coated mold member, wherein the mold assembly comprises a mold cavity at least partially defined by the coated mold member. A lens forming composition is placed in the mold cavity and cured to form a lens that includes a nanocomposite layer, the liquid lens forming composition comprising one or more monomers and one or more initiators.

In another embodiment, a coating layer may be formed on a lens by applying a coating composition to a surface of the lens. The coating composition comprises nanomaterials, one or more initiators, and one or more monomers, wherein the nanomaterials are made by the method comprising: forming a mixture of one or more solvents with one or more stabilizing agents; adding a metal alkoxide to the mixture; and heating the metal alkoxide mixture to form a suspension of nanoparticles in the one or more solvents. The coating layer may be formed on the lens by at least partially curing the coating composition.

### DETAILED DESCRIPTION

Methods and apparatus of various embodiments will be described generally with reference to the drawings for the purpose of illustrating the particular embodiments only, and not for purposes of limiting the same.

As used herein “nanomaterials” refers to nanoparticles, nanospheres, nanowires, and nanotubes. As used herein, “nanoparticle” refers to a solid particle with a diameter of less than 100 nanometers (nm). As used herein, “nanosphere” refers to a substantially hollow particle with a diameter of less than 100 nm. As used herein, “nanowire” refers to a solid cylindrical structure having a diameter of less than 100 nm. As used herein, “nanotube” refers to a hollow cylindrical structure having a diameter of less than 100 nm. As used herein, “nanocomposite” refers to a material that includes nanomaterials dispersed within a polymer. Nanocomposites may exhibit modified mechanical, electrical, and optical properties. A nanocomposite may retain the processability and low cost of the polymer at the macroscopic level while displaying advantageous properties of the nanoparticles at the microscopic level. Selection of the nanomaterial dopant may allow formation of bulk resin with desired properties.

Nanomaterials include, for example, oxides and/or nitrides of elements from columns 2-15 of the Periodic Table. Specific compounds that may be used as nanomaterials include, but not limited to, aluminum cerium oxide, aluminum nitride, aluminum oxide, aluminum titanate, antimony(III) oxide, antimony tin oxide, barium ferrite, barium strontium titanium oxide, barium titanate(III), barium zirconate, bismuth cobalt zinc oxide, bismuth(III) oxide, calcium titanate, calcium zirconate, cerium(IV) oxide, cerium(IV) zirconium(IV) oxide, chromium(III) oxide, cobalt aluminum oxide, cobalt(II, III) oxide, copper aluminum oxide, copper iron oxide, copper(II) oxide, copper zinc iron oxide, dysprosium(III) oxide, erbium(III) oxide, europium(III) oxide, holmium(III) oxide, indium(III) oxide, indium tin oxide, iron(II, III) oxide, iron nickel oxide, iron(III) oxide, lanthanum(III) oxide, magnesium oxide, manganese(II) titanium oxide, nickel chromium oxide, nickel cobalt oxide, nickel(II) oxide, nickel zinc iron oxide, praseodymium(III, IV) oxide, samarium(III) oxide, silica, silicon nitride, strontium ferrite, strontium titanate, tantalum oxide, terbium (III, IV) oxide, tin(III) oxide, titanium carbonitride, titanium(III) oxide, titanium silicon oxide, tungsten (VI) oxide, ytterbium(III) oxide, ytterbium iron oxide, yttrium(III) oxide, zinc oxide, zinc titanate, and zirconium(IV) oxide. It should be understood that the above-listed materials may include minor amounts of contaminants and/or stabilizers (e.g., water and/or acetate) when obtained commercially or synthesized. Nanomaterials used for nanocomposites may be selected based on a variety of properties including, but not limited to, refractive index and hardness. Table 1 compares the bulk hardness and refractive indices of several commercially available nanomaterials.

TABLE 1

| Material | Mohs Hardness | Refractive Index | |
|---|---|---|---|
| Al₂O₃ | 9 | 1.62 | (600 nm) |
| SiO₂ | 6-7 | 1.46 | (600 nm) |
| TiO₂ | 5.5-6 | 2.2-2.7 | (550 nm) |
| ITO | | 2.05 | (550 nm) |
| ZrO₂ | 6.5 | 2.1 | (550 nm) |
| ZnO | 5 | | |
| CeO₂ | 6 | 2.2 | (550 nm) |
| Si₃N₄ | 8.5 | 2.06 | (500 nm) |
| Ta₂O₅ | | 2.16 | (550 nm) |

In an embodiment, nanomaterials used to modify the properties of form polymer composites includes metal oxide nanoparticles. Metal oxide nanoparticles may be formed as non-agglomerated crystalline particles that are electrostatically stabilized. Electrostatic stabilization is believed to occur when ions are adsorbed onto surface of the particles (i.e., anions are attracted to positively charged particles and cations are attracted to negatively charged particles). Particles with large positive or negative charge repel each other and it is believe that agglomeration is therefore inhibited. Organic and inorganic acids and bases and their mixtures may be used as stabilizing agents.

In an embodiment, nanoparticles may be formed by: taking a liquid precursor that includes one or more polar or non-polar solvents (e.g., water, alcohol, ketone toluene, or xylene), a metal alkoxide, and one or more stabilizing agents; placing the mixture in a closed pressure vessel; and heating the mixture at elevated temperature for several hours. After the heat treatment, the dispersion of crystalline nanoparticles typically does not require additional stabilization or de-agglomeration and is ready to use. By changing temperature and time of the reaction, morphology of the nanoparticles may be controlled.

In some embodiments, solvent used to form the nanoparticles may be removed. Agglomeration of the nanoparticles may occur as the solvent is removed. To inhibit nanoparticles from agglomeration, the nanoparticles may be encapsulated with one or more monomers. In one embodiment, one or more monomers and one or more initiators are dissolved in a solvent or mixture of solvents. The mixture of monomer(s) and initiator(s) may be at least partially polymerized. In some embodiments, the one or more of the initiators is a photoinitiator and curing may be accomplished with activating light (e.g., UV light).

As used herein “activating light” means light that may affect a chemical change. Activating light may include ultraviolet light (e.g., light having a wavelength between about 180 nm to about 400 nm), actinic light, visible light or infrared light Generally, any wavelength of light capable of affecting a chemical change may be classified as activating. Chemical changes may be manifested in a number of forms. A chemical change may include, but is not limited to, any chemical reaction that causes a polymerization to take place. Preferably, the chemical change causes the formation of an initiator species within the lens forming composition, the initiator species being capable of initiating a chemical polymerization reaction.

In other embodiments, thermal curing may be used to cure a composition that includes a monomer and one or more thermal initiator(s). Partial polymerization of the monomer may be accomplished by subject the mixture to curing conditions (e.g., activating light and/or heat) with stirring of the mixture. After the at least partially cured monomer has been prepared, the nanoparticle dispersion ma be added to the mixture. To facilitate bonding/attachment of polymer to the nanoparticles, a coupling agent may be employed. Suitable coupling agents include silanes with two functional groups—one to bond with a particle and another to polymerize with monomer.

A variety of metal oxide nanoparticles may be formed. Metal oxide nanoparticles may be formed from metal alkoxides. In some embodiments, transition metal alkoxides may be used as precursors for the formation of metal oxide nanoparticles. Examples of metal alkoxides include compounds having the general formula:

M(OR)ₓ

where M is a transition metal, R is an alkyl group, and x is equal to the oxidation state of the metal M. For example, x is 3 for metals, M, having a +3 oxidation state, and x is 4 for metals having a +4 oxidation state. Examples of transition metals, M, include, but are not limited to aluminum, antimony, erbium, germanium, neodymium, praseodymium, samarium, scandium, strontium, titanium, ytterbium, yttrium, zirconium. Examples of the group, R, include, but are not limited to methoxide, ethoxide, 1-propoxide, 1-butoxide, 2-butoxide, tert-butoxide, iso-butoxide, isopropoxide (2-propoxide), pentoxide, hexoxide, 2-ethylhexoxide, and 2-methoxy-1-ethoxide.

Examples of solvents that may be used to assist in the formation of the nanoparticles include water, alcohols, ketones, and non-polar solvents such as aromatic solvents (e.g., benzene, toluene, xylene, etc.) and alkenes. Examples of alcohols include, but are not limited to: methanol, ethanol, 1-propanol, 1-butanol, 2-butanol, tert-butanol, iso-butanol, isopropanol (2-propanol), pentanol, hexanol, 2-ethylhexanol, and 2-methoxy-1-ethanol. Examples of ketones include, but are not limited to: acetone, 2-butanone, 2-pentanone, 3-pentanone, 3-methyl-2-butanone, methoxyacetone, cyclobutyl methyl ketone, 3-methylcyclopentanone, 2-methylcyclopentanone, 2-hexanone, 3-hexanone, 3-methyl-2-pentanone, 4-methyl-2-pentanone, cyclobutanone, cyclopentanone, and cyclohexenone. Stabilizing agents may include organic, inorganic acids, or mixtures thereof. Organic acids include, but are not limited to: formic acid, acetic acid, glyoxylic acid, propionic acid, glycolic acid, butyric acid, isobutyric acid, methoxyacetic acid, acrylic acid and oleic acid.

Metal oxide nanoparticles may be used as a filler material for many different applications. Applications of metal oxide nanoparticles include, but are not limited to: high refractive index compositions; improved mechanical properties compositions; a UV protective invisible “clear” coating for various surfaces (e.g., automobile surfaces); a filler in paints; a coating for UV lamps to enhance sterilization effect of UV radiation; and to form anti-fogging coatings on glass, mirrors, and other surfaces requiring high optical efficiencies.

### Example

### Nanoparticle Preparation in Ethanol

7.67 mol of ethanol, 1.44 mol of water, 0.42 mol of acetic acid, 0.17 of tetraisopropoxide (TTIP, added dropwise), and 0.003 mol of nitric acid were mixed under constant stirring. The resulting mixture was rigorously stirred for 1 hour. Transparent and stable precursor was transferred to a 600 ml pressure vessel and heat-treated at 115° C. for 160 min. The resulting translucent dispersion contained crystalline 20 nm titanium dioxide nanoparticles.

### Example

### Particle Preparation in Water

25 mol of water, 0.42 mol of acetic acid, 0.13 of TTIP (added dropwise), and 0.003 mol of nitric acid were mixed under constant stirring. The resulting mixture was rigorously stirred for 1 hour. The resulting opaque mixture was transferred to a 600 ml pressure vessel and heat-treated at 130° C. for 90 min. The resulted dispersion was translucent and contained crystalline 5-7 nm titanium dioxide nanoparticles.

### Example

### Particle Preparation in Ethanol with Glycolic Acid

0.77 mol of ethanol, 0.14 mol of water, 0.004 of TTIP (added dropwise), and 0.018 mol of glycolic acid were mixed with constant stirring. The resulting mixture was rigorously stirred for 1 hour. The mixture was orange in color, not transparent, but stable (no precipitate on the bottom of the flask). The mixture was transferred to a 23 ml pressure vessel and heat-treated at 155° C. for 135 min. The resulted dispersion was translucent.

Apparatus, operating procedures, equipment, systems, methods, and compositions for lens coating and curing using activating light are available from Optical Dynamics Corporation in Louisville, Ky.

Polymeric lenses may be produced from lens forming compositions that include monomers and polymerization initiators. Polymeric lenses may be formed by curing a lens forming composition in a mold assembly. A mold assembly may include two mold members that are coupled together to define a mold cavity. The lens forming composition is placed within the mold cavity. Curing of the lens forming composition may be achieved with heat, light, or other methods and/or a combination thereof. Systems and methods for preparing optical lenses using radiation curing techniques and coatings applied to eyeglass lens molds are described in U.S. Pat. Nos. 3,494,326 to Upton; 4,544,572 to Sandvig et al.; 4,728,469 to Danner et al.; 4,758,448 to Sandvig et al.; 4,879,318 to Lipscomb et al.; 4,895,102 to Kachel et al.; 5,364,256 to Lipscomb et al.; 5,415,816 to Buazza et al.; 5,514,214 to Joel et al.; 5,516,468 to Lipscomb, et al.; 5,529,728 to Buazza et al.; 5,689,324 to Lossman et al.; 5,928,575 to Buazza; 5,976,423 to Buazza; 5,989,462 to Buazza et al.; 6,022,498 to Buazza et al.; 6,086,799 to Buazza et al.; 6,105,925 to Lossman et al.; 6,171,528 to Buazza et al.; 6,174,155 to Buazza et al.; 6,174,463 to Buazza et al.; 6,200,124 to Buazza et al.; 6,201,037 to Lipscomb et al.; 6,206,673 to Lipscomb et al.; 6,228,289 to Powers et al.; 6,241,505 to Buazza et al.; 6,280,171 to Buazza; 6,284,159 to Lossman et al.; 6,331,058 to Lipscomb et al.; 6,328,445 to Buazza; 6,367,928 to Buazza et al.; 6,367,928 to Buazza et al.; 6,416,307 to Buazza et al.; 6,419,873 to Buazza et al.; 6,451,226 to Buazza et al.; 6,464,484 to Powers et al.; 6,478,990 to Powers et al.; 6,494,702 to Buazza et al.; 6,528,955 to Powers et al.; 6,557,734 to Buazza et al.; 6,576,167 to Buazza et al.; 6,579,478 to Lossman et al.; 6,612,828 to Powers et al.; 6,632,535 to Buazza et al.; 6,634,879 to Buazza et al.; 6,655,946 to Foreman et al.; 6,673,278 to Buazza et al.; 6,676,398 to Foreman et al.; 6,676,399 to Foreman; 6,698,708 to Powers et al.; 6,702,564 to Foreman et al.; 6,709,257 to Foreman et al.; 6,712,331 to Foreman et al.; 6,712,596 to Buazza et al.; 6,716,375 to Powers et al.; 6,729,866 to Buazza et al.; 6,730,244 to Lipscomb et al.; 6,723,260 to Powers et al.; 6,726,463 to Foreman; 6,752,613 to Foreman; 6,758,663 to Foreman et al.; 6,786,598 to Buazza; 6,790,022 to Foreman; 6,790,024 to Foreman; 6,808,381 to Foreman et al.; 6,840,752 to Foreman; 6,863,518 to Powers; 6,875,005 to Foreman; 6,895,458 to Foreman et al.; 6,899,831 to Foreman; 6,926,510 to Buazza et al.; D467,948 to Powers; D460,468 to Powers et al.; U.S. Patent Application Publication Nos. 2001-0038890 to Buazza et al.; 2001-0047217 to Buazza et al.; 2002-0166944 to Foreman et al.; 2002-0167097 to Foreman et al.; 2002-0167098 to Foreman et al.; 2002-0167099 to Foreman et al.; 2002-0168439 to Foreman et al.; 2002-0168440 to Foreman; 2003-0003176 to Foreman et al.; 2003-0042633 to Foreman et al.; 2003-0042635 to Foreman; 2003-0111748 to Foreman; 2003-0146527 to Powers et al.; 2002-0158354 to Foreman et al.; 2003-0169400 to Buazza et al.; 2002-0185761 to Lattis et al.; 2003-0203065 to Buazza et al.; 2005-0077639 to Foreman et al.; and U.S. patent application Ser. Nos. 09/539,211 to Powers et al. filed Mar. 30, 2000; 10/098,736 to Foreman et al. filed Mar. 15, 2002; and 11/203,422 to Druffel et al. In addition, systems and methods for generating and reading data codes are described in U.S. Pat. Nos. 4,939,354 to Priddy et al.; 5,053,609 to Priddy et al.; and 5,124,536 to Priddy et al.

A coating composition may be formed by mixing one or more monomers with a composition that includes the non-agglomerated nanomaterials. In some embodiments, one or more ethylenically substituted monomers may be added to the colloidal dispersion to form a coating composition. The ethylenically substituted group of monomers include, but are not limited to, C₁-C₂₀ alkyl acrylates, C₁-C₂₀ alkyl methacrylates, C₂-C₂₀ alkenyl acrylates, C₂-C₂₀ alkenyl methacrylates, C₅-C₈ cycloalkyl acrylates, C₅-C₈ cycloalkyl methacrylates, phenyl acrylates, phenyl methacrylates, phenyl(C₁-C₉)alkyl acrylates, phenyl(C₁-C₉)alkyl methacrylates, substituted phenyl (C₁-C₉)alkyl acrylates, substituted phenyl(C₁-C₉)alkyl methacrylates, phenoxy(C₁-C₉)alkyl acrylates, phenoxy(C₁-C₉)alkyl methacrylates, substituted phenoxy(C₁-C₉)alkyl acrylates, substituted phenoxy(C₁-C₉)alkyl methacrylates, C₁-C₄ alkoxy(C₂-C₄)alkyl acrylates, C₁-C₄ alkoxy(C₂-C₄)alkyl methacrylates, C₁-C₄ alkoxy(C₁-C₄)alkoxy(C₂-C₄)alkyl acrylates, C₁-C₄ alkoxy(C₁-C₄)alkoxy(C₂-C₄)alkyl methacrylates, C₂-C₄ oxiranyl acrylates, C₂-C₄ oxiranyl methacrylates, copolymerizable di-, tri- or tetra-acrylate monomers, copolymerizable di-, tri-, or tetra-methacrylate monomers. In some embodiments, a coating composition may include up to about 5% by weight of an ethylenically substituted monomer.

Examples of such monomers include methyl methacrylate, ethyl methacrylate, propyl methacrylate, isopropyl methacrylate, butyl methacrylate, isobutyl methacrylate, hexyl methacrylate, 2-ethylhexyl methacrylate, nonyl methacrylate, lauryl methacrylate, stearyl methacrylate, isodecyl methacrylate, ethyl acrylate, methyl acrylate, propyl acrylate, isopropyl acrylate, butyl acrylate, isobutyl acrylate, hexyl acrylate, 2-ethylhexyl acrylate, nonyl acrylate, lauryl acrylate, stearyl acrylate, isodecyl acrylate, ethylene methacrylate, propylene methacrylate, isopropylene methacrylate, butane methacrylate, isobutylene methacrylate, hexene methacrylate, 2-ethylhexene methacrylate, nonene methacrylate, isodecene methacrylate, ethylene acrylate, propylene acrylate, isopropylene, hexene acrylate, 2-ethylhexene acrylate, nonene acrylate, isodecene acrylate, cyclopentyl methacrylate, 4-methyl cyclohexyl acrylate, benzyl methacrylate, o-bromobenzyl methacrylate, phenyl methacrylate, nonylphenyl methacrylate, benzyl acrylate, o-bromobenzyl phenyl acrylate, nonylphenyl acrylate, phenethyl methacrylate, phenoxy methacrylate, phenylpropyl methacrylate, nonylphenylethyl methacrylate, phenethyl acrylate, phenoxy acrylate, phenylpropyl acrylate, nonylphenylethyl acrylate, 2-ethoxyethoxymethyl acrylate, ethoxyethoxyethyl methacrylate, 2-ethoxyethoxymethyl acrylate, ethoxyethoxyethyl acrylate (SR-256), glycidyl methacrylate, glycidyl acrylate, 2,3-epoxybutyl methacrylate, 2,3-epoxybutyl acrylate, 3,4-epoxybutyl acrylate, 3,4-epoxybutyl methacrylate, 2,3-epoxypropyl methacrylate, 2,3-epoxypropyl acrylate 2-methoxyethyl methacrylate, 2-ethoxyethyl methacrylate, 2-butoxyethyl methacrylate, 2-methoxyethyl acrylate, 2-ethoxyethyl acrylate, 2-butoxyethyl acrylate, tetrahydrofurfuryl acrylate, tetrahydrofurfuryl methacrylate, ethoxylated bisphenol-A-dimethacrylate, ethylene glycol diacrylate, 1,2-propane diol diacrylate, 1,3-propane diol diacrylate, 1,2-propane diol dimethacrylate, 1,3-propane diol dimethacrylate, 1,4-butane diol diacrylate, 1,3-butane diol dimethacrylate, 1,4-butane diol dimethacrylate, 1,5 pentane diol diacrylate, 2,5-dimethyl-1,6-hexane diol dimethacrylate, diethylene glycol diacrylate, polyethylene glycol (400) diacrylate (SR-344), diethylene glycol dimethacrylate (SR-231), trimethylolpropane trimethacrylate, tetraethylene glycol diacrylate (SR-306), tetraethylene glycol dimethacrylate, dipropylene glycol dimethacrylate, trimethylolpropane triacrylate (SR-351), glycerol triacrylate, glycerol trimethacrylate, pentaerythritol triacrylate, pentaerythritol dimethacrylate, pentaerythritol tetracrylate, pentaerythritol tetramethacrylate, dipentaerythritol pentaacrylate (SR-399), ethoxylated₄ bisphenol A dimethacrylate (SR-540), ethoxylated₂ bisphenol A dimethacrylate (SR-348), tris (2 hydroxyethyl) isocyanurate triacrylate (SR-368), ethoxylated₄ bisphenol A diacrylate (SR-601), ethoxylated₄ bisphenol A dimethacrylate (SR-480), ethoxylated₃ trimethylolpropane triacrylate (SR-454), ethoxylated₄ pentaerythritol tetraacrylate (SR494), tridecyl acrylate (SR489), 3-(trimethoxysilyl) propyl methacrylate (PMATMS), 3-glycidoxypropyltrimethoxysilane (GMPTMS), neopentyl glycol diacrylate (SR-247), isobornyl methacrylate (SR-243), tripropylene glycol diacrylate (SR-306), aromatic monoacrylate (CN-131), vinyl containing monomers such as vinyl acetate and 1-vinyl-2 pyrrolidone, epoxy acrylates such as CN 104 and CN 120 which are commercially available from Sartomer Company, and various urethane acrylates such as CN-962, CN-964, CN-980, and CN-965 all commercially available from Sartomer Company

Mixing nanomaterials with one or more monomers creates a coating composition that may be cured to form a nanocomposite coating layer. Curing of a coating composition may be performed using thermal curing, using activating light or both. In order to cure a coating composition, one or more polymerization initiators may be added to the composition. The coating may be cured in the presence or absence of oxygen.

In one embodiment, a coating composition that includes nanomaterials may also include a photoinitiator and/or a co-initiator activated by UV and or visible light. Photoinitiators that may be used include α-hydroxy ketones, α-diketones, acylphosphine oxides, bis-acylphosphine oxides or mixtures thereof. Examples of photoinitiators that may be used include, but are not limited to phenyl bis(2,4,6-trimethylbenzoyl)phenylphosphine oxide, commercially available from Ciba Additives in Tarrytown, New York under the trade name of Irgacure 819, 1-hydroxycyclohexylphenyl ketone, commercially available from Ciba Additives under the trade name of Irgacure 184, 2-hydroxy-2-methyl-1-phenylpropane-1-one commercially available from Ciba Additives under the trade name of Darocur 1173, a mixture of 2,4,6-trimethylbenzoyl-diphenyl-phosphineoxide and 2-hydroxy-2-methyl-1-phenyl-propan-1-one commercially available as Darocur 4265 from Ciba Specialty Chemicals, and benzophenone.

A coating composition that includes nanomaterials may also include coinitiators. In some embodiments, coinitiators include amines. Examples of amines suitable for incorporation into a coating composition include tertiary amines and acrylated amines. The presence of an amine tends to stabilize the antireflective coating composition during storage. The coating composition may be prepared and stored prior to using. Additionally, the presence of oxygen in the coating composition may inhibit curing of the composition. Amines and/or thiols may be added to the composition to overcome inhibition of curing by oxygen present in the coating composition. In some embodiments, the coating composition may slowly gel due to the interaction of the various components in the composition. The addition of amines tends to slow down the rate of gelation without significantly affecting the physical and/or antireflective properties of subsequently formed coatings. In some embodiments, a coating composition may include up to about 5% by weight of amines.

Examples of coinitiators include reactive amine co-initiators commercially available from Sartomer Company under the trade names of CN-381, CN-383, CN-384, and CN-386, where these co-initiators are monoacrylic amines, diacrylic amines, or mixtures thereof.

A coupling agent may also be included in the coating composition. Examples of coupling agents include silanes that have at least two functional groups. Examples of suitable silanes include, but are not limited to: 3-acryloxypropyltrimethoxysilane, 7-oct-1-enyltrimethoxysilane, 3-aminopropyltriethoxysilane, 3-mercaptopropyltrimethoxysilane, 3-glycidoxypropyltrimethoxysilane, allyl triethoxysilane, and methacryloxypropyltrimethoxysilane.

### Example

### Encapsulation of Particles with Monomer and Assembling of Transparent Nanoparticles/Polymer Film

0.09 g of dipentaerythritol pentaacrylate (commercially available as SR-399 monomer from Sartomer Company), 10 wt % of a mixture of 2,4,6-trimethylbenzoyl-diphenyl-phosphineoxide and 2-hydroxy-2-methyl-1-phenyl-propan-1-one (commercially available as Darocur 4265 from Ciba Specialty Chemicals), and 0.005 g of methacryloxypropyltrimethoxysilane were dissolved in 15 g of ethanol. Under rigorous stirring, the monomer and silane were partially polymerized with UV light. Then, 25 g of a 3 wt % titanium dioxide dispersion (from example 1) was added to the mixture. The mixture was spin-coated on a substrate and haze of the substrate was measured (Table 2).

TABLE 2

| Haze of the nanoparticles/ | Haze of the nanoparticles/ |
|---|---|
| polymer composite made | polymer composite made |
| from encapsulated particles | from untreated particles |
| 0.1 | 20.7 |

The encapsulation is believed to introduce steric barriers between the particles and inhibits agglomeration when the solvent is removed. The encapsulation may allow complete removal of solvents present in the dispersion and production of transparent or semi-transparent nanomaterial/monomer mixtures. Thick films (e.g., in security documents) and other solvent-free assemblies could be produced from these nanomaterial/monomer mixtures.

Coating compositions that include nanomaterials may be cured to form a nanocomposite coating on a substrate. For example, to improve the properties of polymeric lenses, one or more nanocomposite coatings may be formed on the outer surface of a polymeric lens. Nanocomposite coatings that may be formed on the outer surface of a polymeric lens may include, but are not limited to, hardcoat (e.g., scratch resistant) coatings, anti-reflective coatings, and photochromic coatings. In some embodiments, these coatings may be formed on the lens by applying the appropriate coating composition to a formed polymeric lens. The coating composition is then cured (either thermally or by use of activating light) to form a nanocomposite coating layer on the outer surface of the lens. This process is herein referred to as an “out-of-mold process.” Alternatively, these coatings may be formed using an in-mold process. An in-mold process involves forming one or more coating layers on a casting surface of one or more mold member. The mold members are then assembled to form a mold assembly and a lens forming composition is placed in a mold cavity defined by the mold assembly. Subsequent curing of the lens forming composition (using activating light, heat or both) will form a polymeric lens within the mold assembly. When the polymeric lens is removed from the mold assembly, the coating layer or layers that were applied to the mold member(s) will adhere to the surface of the formed polymeric lens. Examples of lens forming compositions that may be used are described in U.S. Pat. No. 6,632,535 to Buazza et al. When disposed within the mold cavity, the lens forming composition, in some embodiments, is in contact with the photochromic coating formed on the casting surface of one or both molds.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1-26. (canceled)

27. A method of forming a lens, comprising:
applying a coating composition to a casting face of a mold member, the coating composition comprising nanomaterials, one or more initiators, and one or more monomers, wherein the coating composition is made by the method comprising:
mixing a nanomaterial composition with one or more initiators and one or more monomers, wherein the nanomaterial composition comprises one or more metal oxide particles suspended in a fluid, wherein the metal oxide particles have a diameter of less than about 50 nm, and wherein the metal oxide particles are substantially non-agglomerated;
assembling a mold assembly, the mold assembly comprising the coated mold member, wherein the mold assembly comprises a mold cavity at least partially defined by the coated mold member;
placing a liquid lens forming composition in the mold cavity, the liquid lens forming composition comprising one or more monomers and one or more initiators;
curing the lens forming composition; and
demolding the formed lens from the mold assembly, wherein a hardcoat layer is formed on an outer surface of the formed lens.

28. The method of claim 27, wherein the metal oxide particles are crystalline particles.

29. The method of claim 27, wherein the fluid is water.

30. The method of claim 27, wherein the fluid is an alcohol.

31. The method of claim 27, wherein the fluid is a non-polar solvent.

32. (canceled)

33. The method of claim 27, wherein the metal oxide comprises an oxide of aluminum, antimony, erbium, germanium, neodymium, praseodymium, samarium, scandium, strontium, titanium, ytterbium, yttrium, or zirconium.

34. The method of claim 27, wherein metal oxide is titanium dioxide.

35. The method of claim 27, wherein the metal oxide particles are electrostatically stabilized.

36. A method of forming a lens, comprising:
applying a coating composition to a casting face of a mold member, the coating composition comprising nanomaterials, one or more initiators, and one or more monomers, wherein the nanomaterials are made by the method comprising:
forming a mixture of one or more solvents with one or more stabilizing agents;
adding a metal alkoxide to the mixture; and
heating the metal alkoxide mixture to form a suspension of nanoparticles in the one or more solvents;
assembling a mold assembly, the mold assembly comprising the coated mold member, wherein the mold assembly comprises a mold cavity at least partially defined by the coated mold member;
placing a liquid lens forming composition in the mold cavity, the liquid lens forming composition comprising one or more monomers and one or more initiators;
curing the lens forming composition; and
demolding the formed lens from the mold assembly, wherein a hardcoat layer is formed on an outer surface of the formed lens.

37-40. (canceled)

41. The method of claim 36, wherein at least one of the stabilizing agents comprises an organic acid.

42. The method of claim 36, wherein at least one of the stabilizing agents comprises an inorganic acid.

43. (canceled)

44. (canceled)

45. The method of claim 36, wherein the metal alkoxide comprises an alkoxide of aluminum, antimony, erbium, germanium, neodymium, praseodymium, samarium, scandium, strontium, titanium, ytterbium, yttrium, or zirconium.

46. The method of claim 36, wherein the metal alkoxide comprises titanium dioxide.

47. (canceled)

48. The method of claim 36, wherein the metal alkoxide mixture is heated in a closed pressure vessel at a temperature of between about 100° C. to about 250° C.

49. The method of claim 36, further comprising at least partially polymerizing a monomer; and adding the suspension of nanoparticles to the at least partially polymerized monomer.

50. The method of claim 36, further comprising at least partially polymerizing a composition comprising a monomer and one or more coupling agents; and adding the suspension of nanoparticles to the at least partially polymerized monomer/coupling agent composition.

51. The method of claim 50, wherein the coupling agent comprises a monomer having at least two functional groups.

52. The method of claim 50, wherein the coupling agent comprises a silane coupling agent.

53. A method of forming a coating on a lens, comprising:
applying a coating composition to a lens, the coating composition comprising nanomaterials, one or more initiators, and one or more monomers; wherein the coating composition is made by the method comprising:
mixing a nanomaterial composition with one or more initiators and one or more monomers, wherein the nanomaterial composition comprises one or more metal oxide particles suspended in a fluid, wherein the metal oxide particles have a diameter of less than about 50 nm, and wherein the metal oxide particles are substantially non-agglomerated; and
at least partially curing the coating composition to form a coating layer on the lens.

54.-61. (canceled)

62. A method of forming a coating on a lens, comprising:
applying a composition to a lens, the coating composition comprising nanomaterials, one or more initiators, and one or more monomers; wherein the nanomaterials are made by the method comprising:
forming a mixture of one or more solvents with one or more stabilizing agents;
adding a metal alkoxide to the mixture; and
heating the metal alkoxide mixture to form a suspension of nanoparticles in the one or more solvents; and
at least partially curing the coating composition to form a coating layer on the lens.

63.-81. (canceled)
